(19) United States
(12) Patent Application Publication
(10) Pub. No.: US 2012/0153549 A1
(43) Pub. Date: Jun. 21, 2012

(54) Process for Producing Shaped Metal Bodies Having a Structured Surface

(75) Inventors: Orley Milagres Ferri, Kassel (DE); Thomas Ebel, Handorf (DE); Sergio De Traglia Amancio Filho, Bornsen (DE); Jorge Fernandez Dos Santos, Avendorf (DE)

(73) Assignee: Helmholtz-Zentrum Geesthacht Zentrum Fur Material-und Kustenforschung GmbH, Geesthacht (DE)

(21) Appl. No.: 13/326,611

(22) Filed: Dec. 15, 2011

(30) Foreign Application Priority Data
Dec. 16, 2010 (EP) 10195507.8

(51) Int. Cl. C04B 35/64

(52) U.S. Cl. 264/645

(57) ABSTRACT

The present invention relates to a process for producing shaped metal bodies having a structured surface which can be used as joining elements in the “friction spot joining” process described in the EP application 09015014.5. The shaped metal bodies are produced by means of MIM technology, and are deformed further in the green state or in the brown state after injection moulding to give the desired components.

### BACKGROUND TO THE INVENTION

The present invention relates to a process for producing shaped metal bodies having a structured surface.

The joining of components made of fibre-reinforced plastic by means of new joining technologies such as the “friction spot joining” described in the EP patent application 09015014.5 requires metallic joiners which have at least one structured surface, preferably two structured surfaces, in the submillimetre range and are intended to effect anchoring to the plastic. In aircraft construction, such metal joiners are, for example, metal sheets having a thickness of about 1 mm and having anchor-like structures in the submillimetre range on both sides of the surface.

In aircraft construction, titanium alloys such as TiAl6V4 are used because of the advantageous corrosion properties and magnesium alloys are used in automobile construction because of the high strength to density ratio. However, metal joiners which are composed of these alloys and have a hook-like surface structure in the range of less than 1 mm can be produced only with great difficulty, if at all, by means of conventional processes. Since the desired metallic joiners are a new development, no processes for producing them have hitherto been known from the prior art. Attempts to produce a suitable structure by means of electrolytic deposition have led to shaped metal bodies having unsatisfactory mechanical properties. Cutting machining or casting of the metal joiners is possible only with a very high outlay.

### SUMMARY OF THE INVENTION

It is therefore an object of the invention to provide an economical process for producing shaped metal bodies having a structured surface, in particular shaped metal bodies having at least one structured surface having an anchoring section having an undercut formed at the end facing the metal body, with the structures on the surface being able to have a length of less than 1 mm. An “anchoring section” having an undercut formed at the end facing the metal body means, in the present context, any structure in which at least one dimension of the projection perpendicular to its direction of extension from the shaped metal body increases in a step fashion. An anchoring section in the context of the present invention can have, for example, an angular shape, a hook shape, an anchor shape, a mushroom shape, etc.

The abovementioned object is achieved by a process for producing shaped metal bodies having a structured surface, wherein
(a) metal powder and/or metal alloy powder is mixed with a binder and optionally a further component in a kneader,
(b) the mixture is shaped by injection moulding to give a green part having at least one structured surface section, with the structured surface section having projections,
(c) the surface structured with projections of the green part is deformed in such a way that the projections have an anchoring section at their end facing away from the green part, with an undercut being formed at the end of the anchoring section facing the green part,
(d) the structured green part obtained in this way is subjected to chemical binder removal to give a structured brown part,
(e) the structured brown part which has been subjected to chemical binder removal is subjected to thermal binder removal,
(f) the structured brown part which has been subjected to chemical and thermal binder removal is sintered to form a shaped metal body having a structured surface.

The object is also achieved by a process for producing shaped metal bodies having a structured surface, wherein
(a) metal powder and/or metal alloy powder is mixed with a binder and optionally a further component in a kneader,
(b) the mixture is shaped by injection moulding to give a green part having at least one structured surface, with the structured surface having projections,
(c) the green part structured with projections is subjected to chemical binder removal to give a brown part structured with projections,
(d) the surface structured with projections of the brown part is deformed in such a way that the projections have an anchoring section at their end facing away from the brown part, with an undercut being formed at the end of the anchoring section facing the brown part,
(e) the structured brown part obtained in this way is subjected to thermal binder removal,
(f) the structured brown part which has been subjected to chemical and thermal binder removal is sintered to form a shaped metal body having a structured surface.

The process of the invention utilizes the metal injection moulding process (MIM) for producing a structured first precursor of the shaped metal body and an after-treatment to produce the final shape. The first precursor of the shaped metal body preferably comprises a metal sheet which preferably has a length of from about 3 to 6 cm, more preferably about 4 cm, and a width of from about 1 to 3 cm, more preferably about 2 cm, with the surface structure of the first precursor of the shaped metal body having projections which preferably have a column structure or a cone structure. The column structure or the cone structure can have a round or polygonal base. The column structure preferably has a round base to form a cylindrical shape.

This surface structure of the first precursor of the shaped metal body during the further course of the process of the invention is converted into a structure of a further precursor of the shaped metal body, in such a way that the projections have an anchoring section at their end facing away from the shaped metal body, with an undercut being formed at the end of the anchoring section which faces the further precursor of the shaped metal body. The anchoring section preferably has a mushroom shape or a mushroom-like shape.

The process of the invention exploits the fact that the shaped body of the first precursor of the shaped metal body composed of metal powder or metal alloy powder and binder can be deformed when heated. The surface structured with projections of the first precursor of the shaped metal body is preferably deformed to give a further precursor of the shaped metal body by pressing the shaped body of the first precursor of the shaped metal body into a heated die. The die preferably has semispherical recesses. The reshaping of the first precursor of the shaped metal body can take place in the green state, i.e. after injection moulding (see claim 1), or in the brown state, i.e. after chemical binder removal (see claim 2). Reshaping in the brown state is preferred since no wax component is present in the remaining binder due to the chemical binder removal. Reshaping is particularly preferably carried out by only the tips of the projections of the first precursor of the shaped metal body obtained after injection moulding and optionally chemical binder removal being heated and deformed.

After reshaping, the further precursor of the shaped metal body is subjected to thermal binder removal and sintered to form a shaped metal body having a structured surface, as is described, for example, in the German patent application DE 10 2006 049 844.

### DETAILED DESCRIPTION OF THE INVENTION

A titanium alloy and/or a magnesium alloy is preferably used as metal alloy powder. Particular preference is given to using titanium alloys which contain aluminium and/or vanadium as additional constituents. These additional alloy constituents such as aluminium and/or vanadium are in each case preferably present in an amount of from 2 to 10% by weight, based on the total weight of the alloy. A TiAl6V4 alloy containing about 6% by weight of aluminium, about 4% by weight of vanadium and titanium as balance is most preferred.

The particle size (maximum particle size, determined by sieving) of the metal alloy powder is preferably less than 50 μm, more preferably less than 45 μm, most preferably less than 25 μm.

The binder is preferably selected from the group consisting of: polyamides, polyoxymethylene, polycarbonate, styrene-acrylonitrile copolymer, polyimide, natural waxes and oils, thermosets, cyanates, polypropylene, polyacetate, polyethylene, ethylene-vinyl acetate, polyvinyl alcohol, polyvinyl chloride, polystyrene, polymethyl methacrylate, anilines, mineral oils, water, agar, glycerol, polyvinylbutyryl, polybutyl methacrylate, cellulose, oleic acid, phthalates, paraffin waxes, carnauba wax, ammonium polyacrylate, digylceride stearate and oleate, glyceryl monostearate, isopropyl titanate, lithium stearate, monoglycerides, formaldehyde, octyl phosphate, olefin sulphonates, phosphate esters, stearic acid and mixtures thereof. Preference is given to using at least two binders, and the binder is most preferably composed of paraffin wax, polyethylene wax and stearic acid. The proportion by volume of the binder is preferably less than 60%, more preferably from 20 to 50%.

As further component, preference is given to using boron powder. As an alternative, it is also possible to use carbon fibres or glass fibres as further components, in particular in magnesium alloys.

The mixing in the kneader is preferably carried out at a temperature of from 50 to 250° C., particularly preferably from 90 to 150° C.

The injection moulding, too, is preferably carried out at a melt temperature of from 50 to 250° C., particularly preferably from 90 to 150° C., and preferably at a pressure of from 400 to 800 bar.

The chemical binder removal is preferably carried out in a hydrocarbon bath such as an aliphatic hydrocarbon bath, preferably in a pentane bath, a hexane bath or a heptane bath. The chemical binder removal is particularly preferably carried out in a hexane bath. The chemical binder removal is carried out at a temperature of preferably from 10 to 65° C., more preferably from 30 to 50° C.

The thermal binder removal is carried out at a temperature of less than 450° C., preferably from 200 to 350° C., and preferably under a reduced pressure of preferably from 2 to 20 mbar.

Sintering is preferably carried out at from 80 to 90% of the melting point of the metal or the metal alloy and more preferably in a protective gas atmosphere. The protective gas is preferably argon. As an alternative, sintering can also be carried out under reduced pressure. In this case, the pressure is preferably from 10⁻³ to 10⁻⁵ mbar (absolute). Thermal binder removal and sintering can advantageously take place in the same furnace. Suitable temperature programmes are preferably used for this purpose. In the thermal binder removal and/or in sintering, oxygen-binding material such as titanium powder or magnesium powder is preferably placed in the furnace to minimize the uptake of oxygen by the brown parts.

The process of the invention is preferably carried out in such a way that the uptake of oxygen by the material is less than 0.3% by weight. An oxygen content above about 0.3% by weight in the sintered shaped metal body can lead to embrittlement of the shaped metal body.

The sintered shaped metal body can optionally be after-treated with a laser. The laser after-treatment preferably takes place under a protective gas atmosphere, for example under an argon atmosphere, or a helium atmosphere.

The invention will be illustrated by way of example with the aid of the following figures, in which:

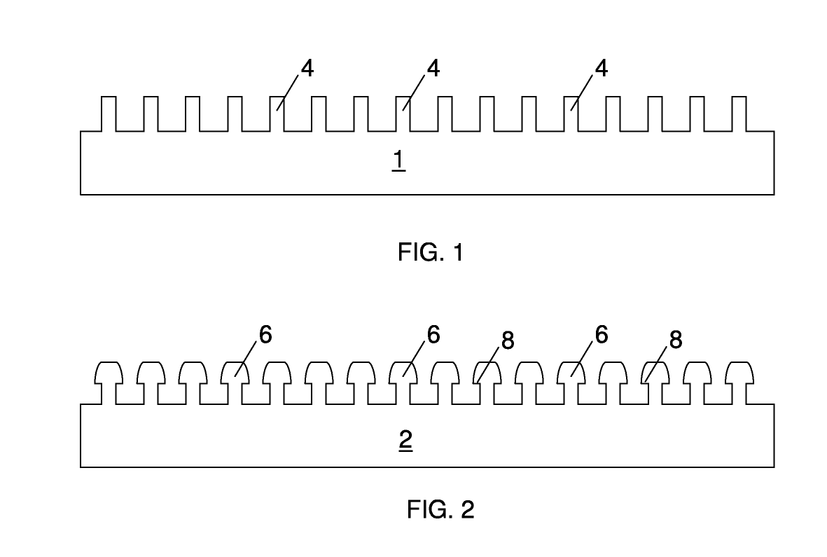

FIG. 1 shows a schematic cross-sectional view of a first structured first precursor of the structured shaped metal body,

FIG. 2 shows a schematic cross-sectional view of a first structured further precursor of the shaped metal body,

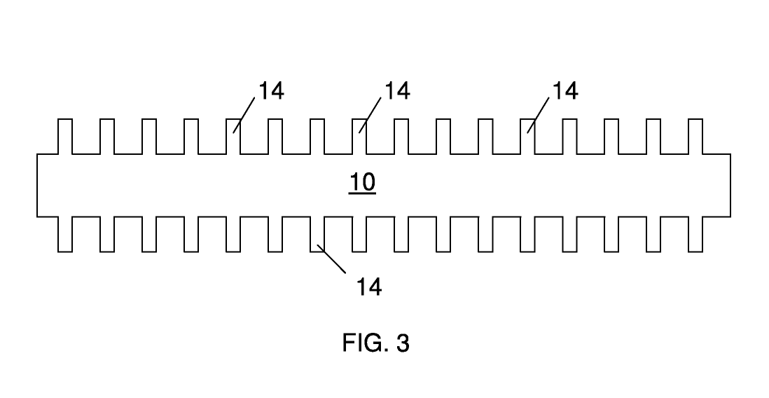

FIG. 3 shows a schematic cross-sectional view of a second structured first precursor of the structured shaped metal body,

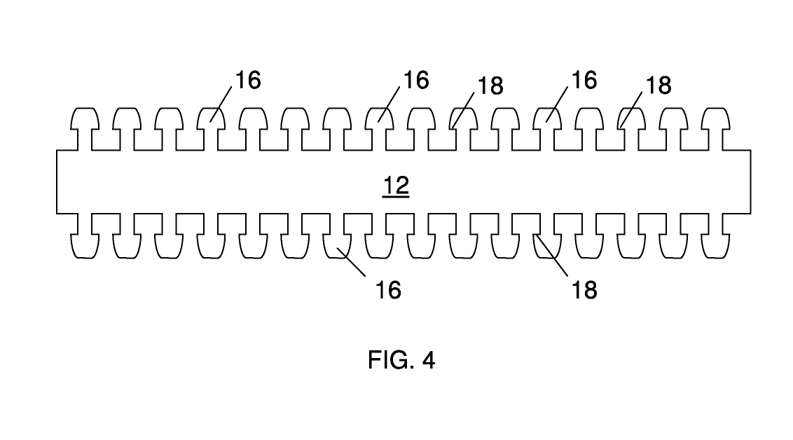

FIG. 4 shows a schematic cross-sectional view of a second structured further precursor of the shaped metal body and

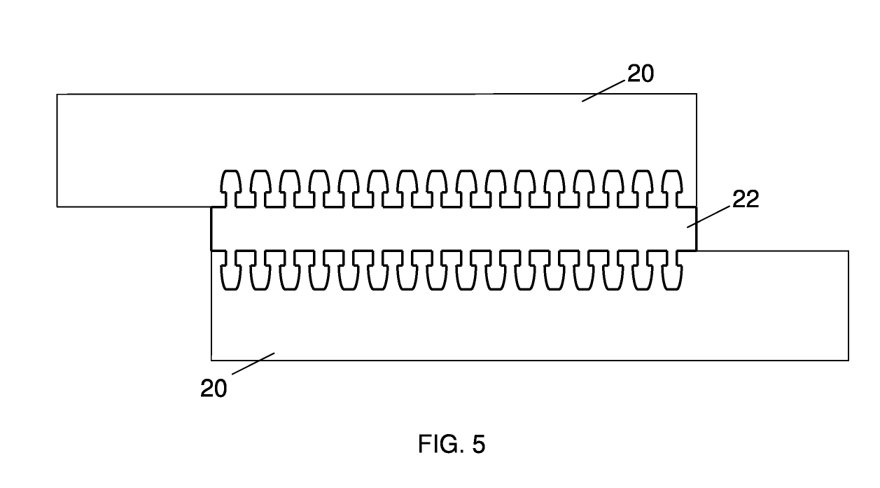

FIG. 5 shows a schematic cross-sectional view of a first structured shaped metal body as joining element between two plastic or CFP components.

FIG. 1 shows a first structured first precursor 1 of the structured shaped metal body after injection moulding, before reshaping to form a further precursor of the structured shaped metal body. The first precursor 1 of the shaped metal body preferably comprises a metal sheet which preferably has a length of from about 3 to 6 cm, more preferably about 4 cm, and a width of from about 1 to 3 cm, more preferably about 2 cm, with the surface structure of the first precursor having projections 4. The projections 4 preferably have a column structure or a cone structure (not shown). The column structure or the cone structure can have a round or polygonal base. The column structure preferably has a round base to form a cylindrical shape.

This surface structure of the first precursor 1 of the shaped metal body is during the further course of the process of the invention transformed into a structure of a further precursor (see FIG. 2) of the shaped metal body, so that the projections 6 have an anchoring section at their end facing away from the shaped metal body, with an undercut 8 being formed at the end of the anchoring section which faces the further precursor of the shaped metal body. The anchoring section preferably has, as shown, a mushroom shape or a mushroom-like shape.

FIG. 3 shows a second structured first precursor 10 of the structure shaped metal body after injection moulding, before reshaping to form a further precursor of the structured shaped metal body. The first precursor 10 of the shaped metal body preferably comprises a metal sheet which preferably has a length of from about 3 to 6 cm, more preferably about 4 cm, and a width of from about 1 to 3 cm, more preferably about 2 cm, with the surface structure of the first precursor having projections 14 on both surfaces of the metal sheet. The projections 14 preferably have a column structure or a cone structure (not shown). The column structure or the cone structure can have a round or polygonal base. The column structure preferably has a round base to form a cylindrical shape.

This surface structure of the first precursor 10 of the shaped metal body is during the further course of the process of the invention transformed into a structure of a further precursor (see FIG. 4) of the shaped metal body, so that the projections 16 have an anchoring section at their end facing away from the shaped metal body, with an undercut 18 being formed at the end of the anchoring section which faces the further precursor of the shaped metal body. The anchoring section preferably has, as shown, a mushroom shape or a mushroom-like shape.

The finished shaped metal body 22 produced therefrom (see FIG. 5) can serve as joining element between two plastic plates or CFP plates 20 which are made of identical or different materials. The join is preferably produced by a process described in the EP patent application 09015014.5, which is hereby incorporated by reference.

The present invention is illustrated by the following example, which is not to be construed as restricting the invention. The ASTM standard to which reference is made in the example is the ASTM standard B 348.

### EXAMPLE

The example describes the production of shaped bodies made of a titanium alloy for examination by means of tensile tests. The process described in the example can, however, also be employed for producing shaped metal bodies according to the invention, in which shaping is carried out in the green or brown state.

Gas-diluted spherical powder having a composition corresponding to ASTM grade 23 (TiAl6V4) and having a particle size of less than 45 μm (maximum particle size, determined by means of sieving) was used as starting material. This was homogeneously mixed under an argon atmosphere with an amorphous boron powder having a particle size of less than 2 μm. The powder mixture was then kneaded under an argon atmosphere with binder constituents composed of paraffin wax, polyethylene-vinyl acetate and stearic acid in a Z-blade mixer at a temperature of 120° C. for 2 hours to give a homogeneous composition and subsequently pelletized.

The resulting pelletized homogeneous composition composed of metal alloy powder, further component and binder was processed on an Arburg 320S injection-moulding machine at a melt temperature of from 100° C. to 160° C. to produce bars for tensile tests. The green parts obtained in this way were subjected to chemical binder removal in hexane at 40° C. for about 10 hours, resulting in the wax component of the binder system dissolving out.

The brown parts obtained in this way were placed under molybdenum covers in a high vacuum furnace having a ceramic-free lining and a tungsten heater, with the volume being selected so that at least 20% of the volume was filled by the brown parts. Oxygen-binding material such as titanium powder was placed outside the covers.

The brown part was firstly subjected in the furnace to thermal binder removal using a suitable temperature programme, with the decomposed residual binder being removed from the furnace chamber by means of a vacuum pump. To carry out sintering, a vacuum of less than 10⁻⁴ mbar (absolute) was firstly generated and the temperature was increased to 1350° C. The sintering time was about two hours.

The measured mechanical properties of the sintered parts are shown by way of example for the use of Ti-6Al-4V-0.5B ELI powder in the following table. A comparison is made with the standard ASTM B348-02 for the corresponding material as compounding alloy.

| | Yield | Tensile | | Long-term |
|---|---|---|---|---|
| | point | strength | Elongation | strength |
| Alloy | [MPa] | [MPa] | [%] | [MPa] |
| Ti-6Al-4V-0.5B | 757 | 861 | 14 | 450 |
| Ti-6Al-4V | 759 | 828 | >10 | 500* |
| (Grade 23) | | | | |

*α-lamellae having a width of 12 μm, heat-treated state

1. Process for producing shaped metal bodies having a structured surface, wherein
(a) metal powder and/or metal alloy powder is mixed with a binder and optionally a further component in a kneader,
(b) the mixture is shaped by injection moulding to give a green part having at least one structured surface section, with the structured surface section having projections,
(c) the surface structured with projections of the green part is deformed in such a way that the projections have an anchoring section at their end facing away from the green part, with an undercut being formed at the end of the anchoring section facing the green part,
(d) the structured green part obtained in this way is subjected to chemical binder removal to give a structured brown part,
(e) the structured brown part which has been subjected to chemical binder removal is subjected to thermal binder removal, the structured brown part which has been subjected to chemical and thermal binder removal is sintered to form a shaped metal body having a structured surface.

2. Process for producing shaped metal bodies having a structured surface, wherein
(a) metal powder and/or metal alloy powder is mixed with a binder and optionally a further component in a kneader,
(b) the mixture is shaped by injection moulding to give a green part having at least one structured surface, with the structured surface having projections,
(c) the green part structured with projections is subjected to chemical binder removal to give a brown part structured with projections,
(d) the surface structured with projections of the brown part is deformed in such a way that the projections have an anchoring section at their end facing away from the brown part, with an undercut being formed at the end of the anchoring section facing the brown part,
(e) the structured brown part obtained in this way is subjected to thermal binder removal,
(f) the structured brown part which has been subjected to chemical and thermal binder removal is sintered to form a shaped metal body having a structured surface.

3. Process according to claim 1, characterized in that a titanium alloy and/or a magnesium alloy is used as the metal alloy powder.

4. Process according to claim 3, characterized in that the titanium alloy contains aluminium and/or vanadium as additional constituents.

5. Process according to claim 4, characterized in that the titanium alloy contains from 2 to 10% by weight of aluminium and/or from 2 to 10% by weight of vanadium, based on the total weight of the alloy.

6. Process according to claim 1, characterized in that the binder is selected from the group consisting of polyamides, polyoxymethylene, polycarbonate, styrene-acrylonitrile copolymer, polyimide, natural waxes and oils, thermosets, cyanates, polypropylene, polyacetate, polyethylene, ethylene-vinyl acetate, polyvinyl alcohol, polyvinyl chloride, polystyrene, polymethyl methacrylate, anilines, mineral oils, water, agar, glycerol, polyvinylbutyryl, polybutyl methacrylate, cellulose, oleic acid, phthalates, paraffin waxes, carnauba wax, ammonium polyacrylate, digylceride stearate and oleate, glyceryl monostearate, isopropyl titanate, lithium stearate, monoglycerides, formaldehyde, octyl phosphate, olefin sulphonates, phosphate esters, stearic acid and mixtures thereof.

7. Process according to claim 6, characterized in that the proportion by volume of the binder in the mixture is less than 60%.

8. Process according to claim 1, characterized in that the injection moulding is carried out at a melt temperature of from 90 to 180° C.

9. Process according to claim 1, characterized in that the chemical binder removal is carried out in a pentane bath, hexane bath or heptane bath.

10. Process according to claim 1, characterized in that the chemical binder removal is carried out at a temperature of from 10 to 65° C.

11. Process according to claim 1, characterized in that the thermal binder removal is carried out at a pressure of from 2 to 20 mbar (200 2000 Pa).

12. Process according to claim 1, characterized in that sintering is carried out in a protective gas atmosphere.

13. Process according to claim 1, characterized in that sintering is carried out under reduced pressure.

14. Process according to claim 1, characterized in that the deformation of the green part or of the brown part to produce a structured surface takes place using a heated die.

15. Process according to claim 1, characterized in that the surface of the green body or of the brown body is given a column structure.

16. Process according to claim 1, characterized in that the surface of the shaped metal body after sintering has a mushroom structure.

17. Process according to claim 2, characterized in that a titanium alloy and/or a magnesium alloy is used as the metal alloy powder.

18. Process according to claim 17, characterized in that the titanium alloy contains aluminium and/or vanadium as additional constituents.

19. Process according to claim 18, characterized in that the titanium alloy contains from 2 to 10% by weight of aluminium and/or from 2 to 10% by weight of vanadium, based on the total weight of the alloy.

20. Process according to claim 2, characterized in that the proportion by volume of the binder in the mixture is less than 60%.
